(19) United States
(12) Patent Application Publication
(10) Pub. No.: US 2013/0208491 A1
(43) Pub. Date: Aug. 15, 2013

(54) STEM LIGHT

(71) Applicant: Charles E. Franklin, Lawrenceville, GA (US)

(72) Inventor: Charles E. Franklin, Lawrenceville, GA (US)

(21) Appl. No.: 13/677,503

(22) Filed: Nov. 15, 2012

Related U.S. Application Data
(60) Provisional application No. 61/560,302, filed on Nov. 16, 2011.

(51) Int. Cl. F21V 33/00

(52) U.S. Cl. CPC F21V 33/00
USPC 362/486

(57) ABSTRACT

In one embodiment of the invention, a stem light includes: a housing configured for removable attachment to a tire stem; a light-emitting component removably coupled to the housing and configured to emit a light signal, wherein the light-emitting component includes a reflective material to increase a light signal output efficiency; and a cap coupled to the light-emitting component.

### CROSS-REFERENCE TO RELATED APPLICATION

This application claims a priority to and claims the benefit of U.S. Provisional Application No. 61/560,302, filed on 16 Nov. 2011. U.S. Provisional Application No. 61/560,302 is hereby incorporated herein by reference.

### TECHNICAL FIELD

Embodiments of the invention relate generally to stem lights.

### BACKGROUND

Accessory lights of different types are commonly used in vehicles for added visibility of the vehicle during dark conditions or night time, or for producing a decorative lighting effect. Reflectors (which are not light sources) have also been used for mounting on wheels of bicycles, motor cycles, or other vehicles.

However, there is a continuing need to provide consumers or vehicle operators with a convenient and simple device for providing sufficient illumination in the event of tire problems (e.g., flat tires or tires having a low air pressure) or other vehicle-related problems. For example, the air valve stem (which provides the air input into a tire) is small in size and is often difficult for the vehicle operator to locate during dark conditions or night time.

One commercially-available product from Yellow Waves LLC is a cap with light emitting diode (LED) for installation onto an air valve stem of tires and sold under the name Koolight™. U.S. Pat. No. 6,467,939 and U.S. Publication 2006/0072325 also disclose air valve stem caps with an LED device that can be mounted on tire stems. While these devices are suited for their intended purposes, these devices fail to conserve battery power and, therefore, are not able to provide an extended or longer time length output of light. Additionally, these devices fail to compensate for light losses that are common in commercially available LEDs.

Based on the above discussion, the current technology is limited in its capabilities and suffers from at least the above constraints and deficiencies.

### SUMMARY

In one embodiment of the invention, a stem light includes: a housing configured for removable attachment to a tire stem; a light-emitting component removably coupled to the housing and configured to emit a light signal, wherein the light-emitting component includes a reflective material to increase a light signal output efficiency; and a cap coupled to the light-emitting component.

In another embodiment of the invention, a stem light includes: a housing configured for removable attachment to a tire stem; means for emitting a light signal, said emitting means removably coupled to the housing, said emitting means including a reflective means to increase a light signal output efficiency; and a cap coupled to the emitting means.

In yet another embodiment of the invention, a method of assembling a stem light includes: providing a light-emitting component, wherein the light-emitting component includes a reflective material to increase a light signal output efficiency; attaching a cap on the light-emitting component; providing a housing; and removably attaching the light-emitting component to the housing.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

Additionally, the left-most digit of a reference number may identify the drawing in which the reference number first appears.

FIG. 1 is a cross-sectional view of a stem light, in accordance with an embodiment of the invention.

FIG. 2 is a cross-sectional view of the stem light of FIG. 1 as shown as separated components, in accordance with an embodiment of the invention.

FIG. 3 is a block diagram of a power source that is used with a stem light in accordance with an embodiment of the invention.

FIG. 4 is a block diagram of a power source that is used with a stem light in accordance with another embodiment of the invention.

FIG. 5 is a block diagram of a power source that is used with a stem light in accordance with another embodiment of the invention.

FIG. 6 is a method of assembling a stem light, in accordance with an embodiment of the invention.

### DETAILED DESCRIPTION OF PREFERRED EMBODIMENTS

In the description herein, numerous specific details are provided, such as examples of components, parts, structures, and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, structures, and/or the like. In other instances, well-known structures, materials, or operations are not shown or described in detail to avoid obscuring aspects of embodiments of the invention. Additionally, the figures are representative in nature and their shapes are not intended to illustrate the precise shape or precise size of any element and are not intended to limit the scope of the invention.

Those skilled in the art will understand that when an element or part in the drawings is referred to as being “on” (or “connected” to or “coupled” to or “attached” to) another element, it can be directly on (or attached to) the other element or intervening elements may also be present. Furthermore, relative terms such as “inner”, “outer”, “upper”, “above”, “lower”, “beneath”, and “below”, and similar terms, may be used herein to describe a relationship of one element to another element. It is understood that these terms are intended to encompass different orientations of the device in addition to the orientation depicted in the figures.

Although the terms first, second, and the like may be used herein to describe various elements, components, parts, regions, layers and/or sections, these elements, components, parts, regions, layers, chambers, and/or sections should not be limited by these terms. These terms are only used to distinguish one element, component, part, region, layer, chamber, or section from another element, component, part, region, layer, chamber, or section. Thus, a first element, component, part, region, layer, chamber, or section discussed below could be termed a second element, component, part, region, layer, chamber, or section without departing from the teachings of the present invention.

Embodiments of the invention are described herein with reference to cross-sectional view illustrations that are schematic illustrations of representative embodiments of the invention. As such, variations from the shapes of the illustrations as a result of, for example, manufacturing techniques and/or tolerances are expected. For purposes of avoiding in overcrowding the drawings, the elements shown in the drawings are not necessarily drawn to scale, and the elements may be larger in physical size or smaller in physical size than as shown in the drawings.

Embodiments of the invention should not be construed as limited to the particular shapes of the regions or components/parts/elements illustrated herein but are to include deviations in shapes that result, for example, from manufacturing or particular implementations. For example, an element illustrated or described as square or rectangular may typically have rounded or curved features due to normal manufacturing tolerances or due to a particular implementation. Thus, the elements illustrated in the figures are schematic in nature and their shapes are not intended to illustrate the precise shape of an element of a device and are not intended to limit the scope of the invention.

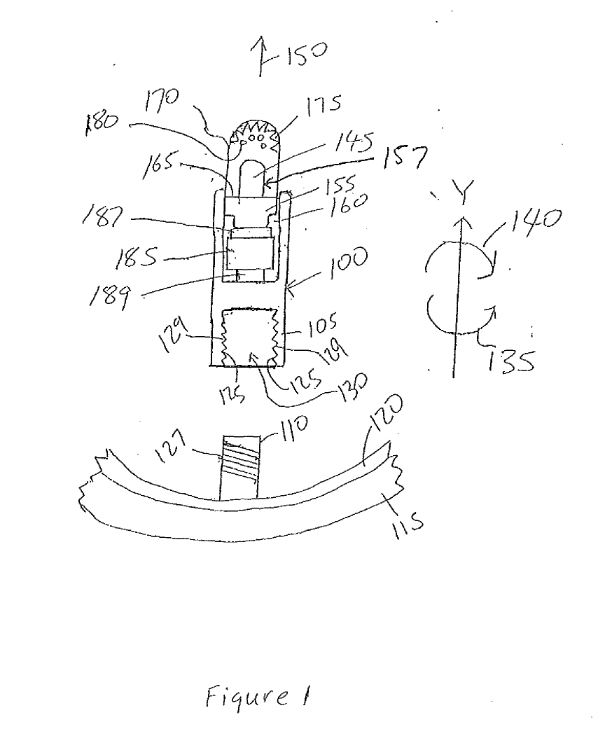

FIG. 1 is a cross-sectional view of a stem light 100, in accordance with an embodiment of the invention. The stem light 100 includes a housing 105 (i.e., a bottom cap 105) that can be connected to (and disconnected from) an air valve stem 110 of a tire 115. In an embodiment of the invention, the housing 105 is a non-conductor such as, by way of example and not by way of limitation, a sealed plastic material. In an embodiment of the invention, the housing 105 is formed by a substantially waterproof enclosure.

As known to those skilled in the relevant art(s), for tubeless pneumatic tires used by vehicles, the stem 110 is connected directly to the wheel rim 120. As also known to those skilled in the relevant art(s), for tires that include an inner tube, the stem 110 is part of the inner tube and protrudes from the wheel rim 120 by fitting through an opening in the wheel rim 120. Embodiments of the invention are intended to connect to any type of air valve stem such as, for example, tires with or without an inner tube.

In the discussion herein, the terms that refer to a direction (e.g., upper, lower, left, right, above, beneath, and other directional terms) are used to denote a direction or position in reference to the stem light 100 when viewed from the perspective of a user who is holding the stem light 100 in an upright orientation and the stem 110 is positioned below the stem light 100.

In an embodiment of the invention, the stem light 100 can be removably attached to the stem 110 by engaging the stem light treads 125 (of the housing 105) with the stem threads 127 (of the stem 110). Two components are removably coupled (or removably attached or removably inserted) means that two different components can be attached together or detached apart. The stem light threads 125 are formed in a wall 129 that surrounds an opening 130 for threadedly receiving the stem 110. Therefore, the stem light 100 can be removably attached to the stem 110 by twisting the stem light 100 in a first rotational direction 135 with respect to the Y-axis when the stem light 100 is mounted on the stem 110. The stem light 100 can be detached from the stem 110 by twisting the stem light 100 in a second rotational direction 140 (which is opposite of the first rotational direction 135) when the stem light 100 is mounted on the stem 110.

In another embodiment of the invention, the housing threads 125 are omitted and, instead, the housing 105 is removably coupled to the stem 110 by a pressure coupling or by other methods that are known to those skilled in the relevant art(s).

In an embodiment of the invention, the stem light 100 includes a light source 145 for generating a light signal 150. The light signal 150 can have any suitable color such as, by way of example and not by way of limitation, red, green, blue, gold, purple, yellow, or another color.

The light source 145 may be any suitable type of light source that is known to those skilled in the relevant art(s). By way of example and not by way of limitation, the light source 145 is a light emitting diode (LED), an electro luminescence light source, a small-sized light bulb, a neon lamp, a fluorescent lamp, or another suitable type of light source. Light sources, such as LEDs, are commercially available from various vendors. As also known to those skilled in the relevant art(s), if the light source 145 is an LED, then the shape of the light source 145 may be in the form of stacked semiconductor layers for generating the light signal 150 and may not necessarily be in the shape as shown in FIG. 1.

In an embodiment of the invention, the light source 145 may be a non-blinking LED (or other non-blinking light-emitting component 145). If the light source 145 is a non-blinking LED (or other non-blinking light-emitting component 145), then the light emitted by the light source 145 will not flash or will not blink, and the light source 145 will stay on. In yet another embodiment of the invention, the light source 145 (light-emitting component 145 or emitting means) may be a blinking (or flashing) LED or another type of light-emitting component 145 that is configured to emit a blinking light or a flashing light. Blinking LEDs are commercially available from various vendors or manufacturers such as, for example, FlashingBlinkyLights.com, Incorporated, Sun Valley, Calif. In an embodiment of the invention, other suitable lighting components may be used as a light source 145.

In an embodiment of the invention, the light source 145 is mounted on a submount 155 which is removably inserted into and removably coupled to the housing 105. The light source 145 and submount 155 form the light-emitting component 157 of the stem light 100.

In an embodiment of the invention, the housing 105 includes a cavity 160 for receiving the submount 155 and light source 145. As will also be discussed below, in an embodiment of the invention, the housing 105 includes threads that are formed on the wall surrounding the cavity 160, where these threads are configured to threadedly receive the threads on the exterior side wall of the submount 155. As a result, the submount 155 can be twisted in the first rotational direction 135 to removably secure the submount 155 (and light source 145) to the housing 105 and within the cavity 160. The submount 155 can be twisted in the second rotational direction 140 to remove the submount 155 (and light source 145) away from the housing 105 and cavity 160.

In another embodiment of the invention, the light-emitting component 157 is removably coupled to the housing 105 by a pressure coupling or by other methods that are known to those skilled in the relevant art(s).

In an embodiment of the invention, the submount 155 is formed by a reflective material. In another embodiment of the invention, the mounting surface 165 is coated with a reflective material, wherein the mounting surface 165 mounts the light source 145. The reflective material can be made of many different materials. By way of example and not by way of limitation, the reflective material is aluminum (Al), silver (Ag), another reflective metal, a suitable reflective alloy, a dielectric reflector, a hybrid reflector which includes both metal and dielectric layers, and/or another suitable reflective material.

The reflective material in the submount 155 advantageously increases the efficiency of light output transmission from the light source 145 because the reflective material will reflect the light signal 150 that transmits toward the submount 155. Without the reflective material in the submount 155, there is a likelihood that the submount 155 will absorb some of the light signal 150 and this absorbed light is a light loss that decreases the efficiency of the light output of the stem light 100. Therefore, an embodiment of the invention advantageously provides a stem light 100 that provides an increased efficiency of light output transmission when compared to conventional technology.

In an embodiment of the invention, the stem light 100 includes a cap 170 that covers the light source 145. The cap 170 provides environmental protection and physical protection to the light source 145. The cap 170 is sufficiently transparent and/or translucent so that the light source 145 generates light signals 150 that transmits through the cap 170 and that are sufficiently visible to a user of the stem light 100. Since the cap 170 is transparent or translucent, the cap 170 will cause no loss (in the ideal condition) or minimal loss to the light signals 150 as the light signals 150 transmit through the material formed by the cap 170.

In an embodiment of the invention, the cap 170 may be formed by various suitable materials that are known to those skilled in the relevant art(s). By way of example and not by way of limitation, the cap 170 may be formed by resin, silicon, glass, or another suitable material or combination of suitable materials.

In an embodiment of the invention, the cap 170 can have a material with a color such as, by way of example and not by way of limitation, red, green, blue, gold, purple, yellow, or another color. By way of example and not by way of limitation, the color can be provided to the cap 170 by use of a dye material.

In an embodiment of the invention, the cap 170 can have a textured surface 175 which will enhance the diffusion of the light signal 150 and increase the visibility of the light signal 150 to the user of the stem light 100. In another embodiment of the invention, the textured surface 175 is omitted from the cap 170.

In an embodiment of the invention, a textured surface 175 is a surface that has smaller optical features (and/or small non-planar features on the exterior surface of the cap 170) and includes mechanical or physical surface roughness (e.g., surfaces that are physically cut or laser cut), crystallographic surfaces (e.g., chemically developed surface roughness), and/or lenticular surfaces (e.g., regular, patterned, and/or lens-like roughness). As known to those skilled in the relevant art(s), based upon Snell's Law, such a textured surface presents light photons with a large number of small surfaces at numerous angles and this condition increases the number of photons that refract and exit externally from the cap 170, rather than reflecting internally within the cap 170.

In an embodiment of the invention, the cap 170 can also include a wavelength down-converting material 180 for decreasing the wavelength of at least some of the light signals 150 from the light source 145. In another embodiment of the invention, the material 180 is omitted from the cap 170. By way of example and not by way of limitation, the material 180 is formed by phosphors. As known to those skilled in the relevant art(s), if the light signal 150 is a blue light, then the material 180 will convert some of the blue light into yellow light, and the unconverted blue light will mix with the yellow light. This mix of blue light and yellow light results in a white light that is visible to the user of the stem light 100.

In an embodiment of the invention, a power source 185 provides power for allowing the light source 145 to generate the light signals 150. The power source 185 can be disposed within the cavity 160 and can include a positive contact 187 and a ground contact 189. In one embodiment of the invention, the power source 185 is removably disposed within the cavity 160 and, therefore, the power source 185 is replaceable with another power source 185.

The power source can be, by way of example and not by way of limitation, at least one battery, or one or more batteries. However, other types of suitable portable power sources may be used as a power source. As will be discussed below, the power source can also be formed by a solar energy source such as, for example, a solar cell.

In an embodiment of the invention, the submount 155 is sufficiently electrically conductive to permit the power source 185 to transmit power to the light source 145. As a result, when the submount 155 is placed in electrical contact with the positive contact 187, the light source 145 is electrically connected to the power source 185 so that a closed electrical circuit is formed to permit the power source 185 to transmit power to energize the light source 145 and the light source 145 will emit the light signal 150. Therefore, the light source 145 is on.

In an embodiment of the invention, the submount 155 is formed by an electrically conductive material such as, for example, SiC (silicon carbide). However, in another embodiment of the invention, the submount 155 can be formed by other suitable electrically conductive material so long as the material does not interfere with the operation of the light source 145.

When the submount 155 is not in electrical contact with the positive contact 187, the light source 145 is electrically disconnected from the power source 185 so that an open electrical circuit is formed that will not permit the power source 185 to transmit power to energize the light source 145, and the light source 145 will not be able to emit the light signal 150. Therefore, the light source 145 is off.

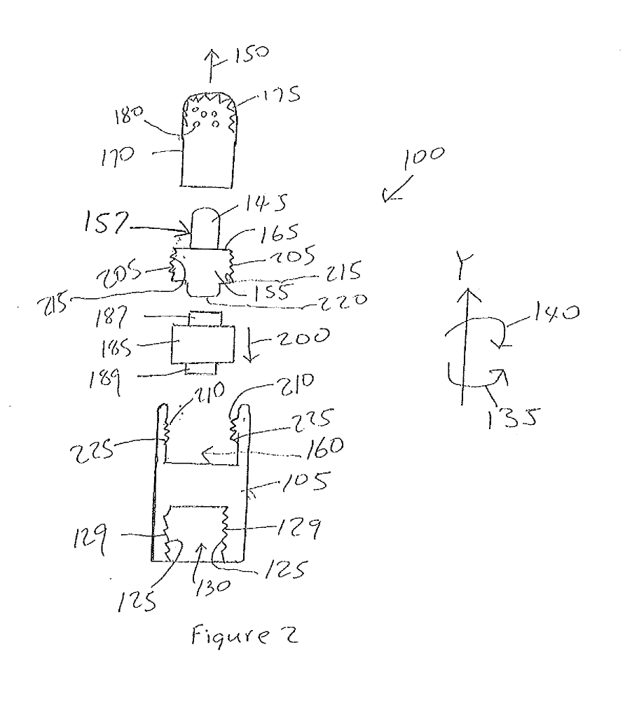

FIG. 2 is a cross-sectional view of the stem light 100 of FIG. 1 as shown as separated components, in accordance with an embodiment of the invention.

The power source 185 can be inserted 200 into the cavity 160 of the housing 105. The light source 145 and submount 155 can also be inserted 200 into the cavity 160.

In an embodiment of the invention, the cap 170 and the submount 155 are two separate components that are attached together during assembly. In another embodiment of the invention, the cap 170 is integrated with the submount 155 during the manufacturing process.

In an embodiment of the invention, the submount 155 can be removably attached to the housing 105 by engaging the submount treads 205 (of the submount 155) with the cavity threads 210 that are around the cavity 160. The submount threads 205 are formed in a side wall 215 of the submount 155. The electrically conductive bottom wall 220 of the submount 155 is placed in electrical contact with the positive contact 187 of the power source 185 so that the power source 185 can provide power to the light source 145 in order to energize the light source 145.

The cavity threads 210 are formed on the cavity side wall 225 that surrounds the cavity 160 and will threadedly receive the submount threads 205. Therefore, the submount 155 (and light source 145) can be removably attached to the housing 105 by twisting the submount 155 in the first rotational direction 135 with respect to the Y-axis when the submount is inserted into the cavity 160. The submount 155 (and light source 145) can be detached from the housing 105 by twisting the submount 155 (and light source 145) in the second rotational direction 140.

In an embodiment of the invention, the light source 145 is turned ON by the user by twisting the cap 170 (and light-emitting component 157) in the first rotational direction 135 so that the bottom wall 220 of the submount 155 is placed in electrical contact with the positive contact 187 of the power source 185. The light source 145 is turned OFF by the user by twisting the cap 170 (and light-emitting component 157) in the second rotational direction 140 so that the bottom wall 220 of the submount 155 is not placed in electrical contact with the positive contact 187 of the power source 185.

In another embodiment of the invention, the submount threads 205 and cavity threads 210 are omitted and, instead, the submount 155 and light source 145 are removably coupled to the housing 105 by a pressure coupling or by other methods that are known to those skilled in the relevant art(s).

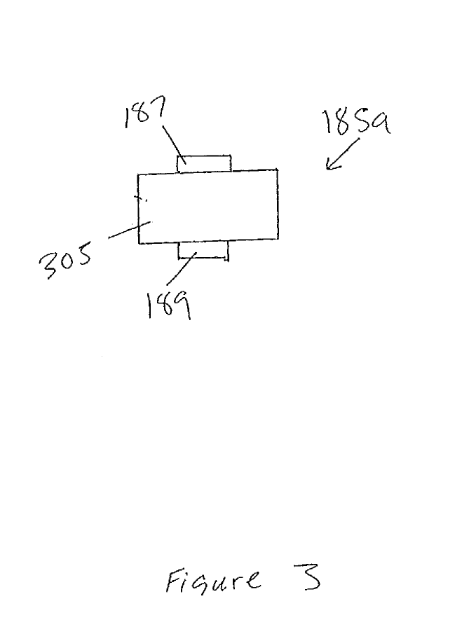

FIG. 3 is a block diagram of a power source 185a that is used with a stem light in accordance with an embodiment of the invention. The power source 185a is one example of the generic power source 185 of FIG. 1. The power source 185a can be inserted into the cavity 160 of the housing 105 as similarly shown for the generic power source 185 in FIG. 1.

In one embodiment, the power source 185a is at least one battery 305, or one or more batteries 305. In the example of FIG. 3, the power source 185a is illustrated as a single battery 305 for ease of illustration.

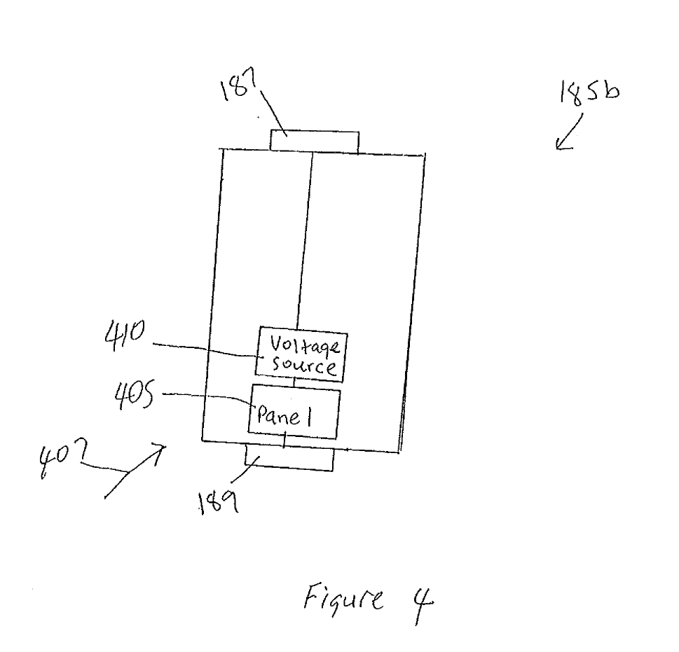

FIG. 4 is a block diagram of a power source 185b that is used with a stem light in accordance with another embodiment of the invention. The power source 185b is another example of the generic power source 185 of FIG. 1. The power source 185b can be inserted into the cavity 160 of the housing 105 as similarly shown for the generic power source 185 in FIG. 1.

In an embodiment, the power source 185b includes a solar charging panel 405 that receives solar light 407 as solar energy for charging the solar cell 410 which functions as a voltage source for energizing the light source 145. The solar cell 410 is electronically coupled to the positive contact 187.

The solar cell 410 converts the light 407 received by the solar panel 405 into voltage signals. These voltage signals from the solar cell 410 can provide power to energize the light emitter 157 or can provide power to a rechargeable battery (not shown in FIG. 4) to energize the light emitter 157. Various known circuit elements such as, for example, circuit traces, can be included in the components disclosed herein and are not necessarily shown in FIGS. 1 through 5 so as to not overcrowd the drawings.

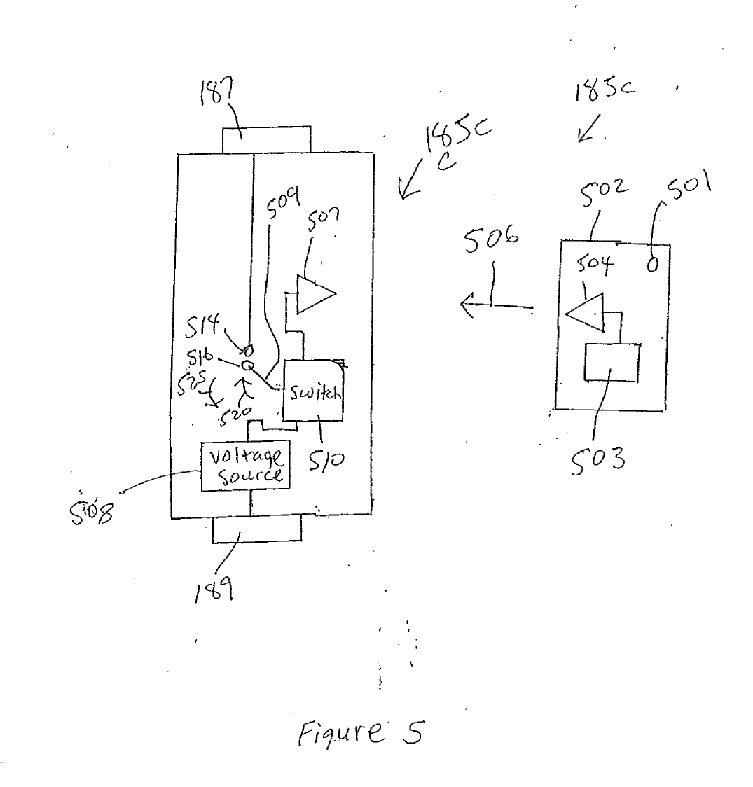

FIG. 5 is a block diagram of a power source 185c that is used with a stem light in accordance with another embodiment of the invention. The power source 185c is another example of the generic power source 185 of FIG. 1. The power source 185c can be inserted into the cavity 160 of the housing 105 as similarly shown for the generic power source 185 in FIG. 1.

In an embodiment of the invention, the user of the stem light 100 can remotely turn ON and turn OFF the light source 145 by use of a remote control device 502. In an embodiment, the remote control device 502 can include a key ring hole 501 that can conveniently receive a key ring (not shown in FIG. 5) so that the remote control device 502 can also be removably coupled to the key ring of the user.

In an embodiment, the user can press the actuator 503 in the remote control device 502. In response to pressing the actuator 503, the transmitter 504 (in remote control device 502) will transmit the control signal 506 that is received by the receiver 507 in the power source 185c.

In response to receiving the control signal 506, the switch 510 in the power source 185c will connect the contact 516 of the connector 509 to the contact 514 which is in electrical contact with the positive contact 187. The voltage source 508 is electrically connected to the connector 509 and contact 516. In response to the control signal 506, the switch 510 will move the connector 509 in the direction 520 so as to electrically couple the contact 516 with the contact 514. As a result, the voltage source 508 is electrically connected to the positive contact 187 and will be able to provide power to energize the light source 145. Therefore, the user can press the actuator 503 at an initial occurrence to remotely allow the light source 145 to emit the light signal 150 and remotely turn ON the stem light 100.

In response to the user pressing the actuator 503 at another occurrence after the initial occurrence of pressing the actuator 503, the transmitter 504 will terminate in transmitting the control signal 506. In response to the receiver 507 no longer receiving the control signal 506, the switch 510 will move the actuator 509 in the direction 525 so that the actuator 509 electrically disconnects the contact 516 from the contact 514. As a result, the electronic circuit between the voltage source 508 and the positive node 187 is opened, and the voltage source 508 will not be able to provide power to the light source 145. Therefore, the user can press the actuator 503 at this another occurrence to remotely not allow the light source 145 to emit the light signal 150 and remotely turn OFF the stem light 100. As a result, the remote control device 502 allows the conservation of the power in the voltage source 508 by allowing the user to remotely turn ON and remotely turn OFF the light source 145.

The user can again press the actuator in a subsequent occurrence so as to remotely turn ON the light source 145 as similarly discussed above.

In an embodiment, the switch 510 is a transistor switch that is responsive to the control signal 506 and that moves the contact 516 into electrical contact with the contact 514 and moves the contact 516 into electrical isolation from the contact 514. In another embodiment, the switch 510 can be a solenoid switch of a customized miniature size.

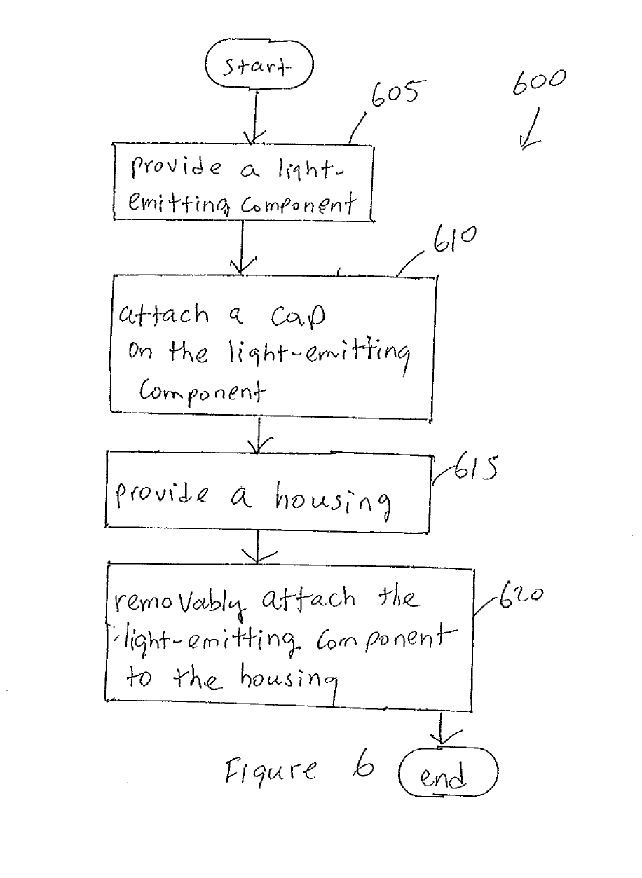

FIG. 6 is a method 600 of assembling a stem light, in accordance with an embodiment of the invention. In block 605, a light-emitting component 157 is provided. In FIG. 1, the light-emitting component 157 includes the light source 145 and a submount 155 that supports the light source 145. In block 610, a cap 170 is attached to the light-emitting component 155. In FIG. 1, the cap 170 is attached to the submount 155.

In block 615, a housing 105 is provided. In block 620, the light-emitting component 157 is removably attached to the housing 105.

A power source 185 can also be removably attached to the housing 105, and the power source 185 provides the voltage to power the light-emitting component 157.

Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A stem light comprising:
a housing configured for removable attachment to a tire stem;
a light-emitting component removably coupled to the housing and configured to emit a light signal, wherein the light-emitting component includes a reflective material to increase a light signal output efficiency; and
a cap coupled to the light-emitting component.

2. The stem light of claim 1, wherein the light-emitting component comprises a submount and a light source disposed on the submount.

3. The stem light of claim 2, wherein the submount includes the reflective material.

4. The stem light of claim 1, wherein the housing includes housing threads.

5. The stem light of claim 1, wherein the light-emitting component is configured to be twisted in a first rotational direction to turn on the light-emitting component and is configured to be twisted in a second rotational direction to turn off the light-emitting component.

6. The stem light of claim 1, wherein the cap is transparent.

7. The stem light of claim 1, wherein the cap includes a wavelength down-converting material.

8. The stem light of claim 1, wherein the cap includes a textured surface to enhance a diffusion of the light signal.

9. The stem light of claim 1, wherein the housing is configured to receive a power source to provide power to the light-emitting component.

10. The stem light of claim 1, wherein the power source comprises at least one battery.

11. The stem light of claim 1, wherein the power source comprises a solar cell.

12. The stem light of claim 1, wherein the power source comprises a voltage source and a switch that is remotely controlled for electrically connecting and electrically disconnecting the voltage source to the light-emitting component.

13. The stem light of claim 1, wherein the light-emitting component emits the light signal having a color comprising one of red, green, blue, gold, yellow, and purple.

14. The stem light of claim 1, wherein the cap comprises a coating material having a color comprising one of red, green, blue, gold, yellow, and purple.

15. A stem light comprising:
a housing configured for removable attachment to a tire stem;
means for emitting a light signal, said emitting means removably coupled to the housing, said emitting means including a reflective means to increase a light signal output efficiency; and
a cap coupled to the emitting means.

16. The stem light of claim 15, wherein the emitting means comprises a submount and a light source disposed on the submount.

17. The stem light of claim 16, wherein the submount includes the reflective material.

18. The stem light of claim 15, wherein the emitting means is configured to be twisted in a first rotational direction to turn on the emitting means and is configured to be twisted in a second rotational direction to turn off the emitting means.

19. A method of assembling a stem light, the method comprising:
providing a light-emitting component, wherein the light-emitting component includes a reflective material to increase a light signal output efficiency;
attaching a cap on the light-emitting component;
providing a housing; and
removably attaching the light-emitting component to the housing.

20. The method of claim 19, further comprising: removably attaching a power source to the housing.
